(19) United States
(12) Patent Application Publication
(10) Pub. No.: US 2016/0293280 A9
(43) Pub. Date: Oct. 6, 2016

(54) CRDM INTERNAL HYDRAULIC CONNECTOR

(71) Applicant: BWXT mPower, Inc., Charlotte, NC (US)

(72) Inventor: Scott J SHARGOTS, FOREST, VA (US)

(21) Appl. No.: 13/860,058

(22) Filed: Apr. 10, 2013

Related U.S. Application Data
(63) Continuation-in-part of application No. 13/405,405, filed on Feb. 27, 2012.
(60) Provisional application No. 61/625,749, filed on Apr. 18, 2012.

(51) Int. Cl. G21C 7/16; G21C 7/12

(52) U.S. Cl. CPC G21C 7/16; G21C 7/12

(57) ABSTRACT

In a nuclear reactor, an internal control rod drive mechanism (CRDM) includes a motor and a hydraulically driven element connected by at least one hydraulic line with at least one hydraulic connector disposed on a mounting plate of the internal CRDM. A support element mounted in the nuclear reactor includes at least one hydraulic connector. The internal CRDM is supported on the support element by its mounting plate with each hydraulic connector of the internal CRDM mated with a corresponding hydraulic connector of the support element. The hydraulically driven element may be a piston controlling SCRAM, driven by coolant water, and the coolant water pressure in the at least one hydraulic line is higher than the coolant water pressure in the nuclear reactor. The mating of each hydraulic connector of the internal CRDM with a corresponding hydraulic connector of the support element may be a leaky mating that leaks coolant water into the pressure vessel.

This application is a continuation-in-part of U.S. application No. 13/405,405 filed Feb. 27, 2012. U.S. application No. 13/405,405 filed Feb. 27, 2012 is hereby incorporated by reference in its entirety. This application claims the benefit of U.S. Provisional Application No. 61/625,749 filed Apr. 18, 2012. U.S. Provisional Application No. 61/625,749 filed Apr. 18, 2012 is hereby incorporated by reference in its entirety.

### BACKGROUND

The following relates to the nuclear reactor arts, nuclear power generation arts, nuclear reactor control arts, nuclear reactor electrical power distribution arts, and related arts.

In nuclear reactor designs of the integral pressurized water reactor (integral PWR) type, a nuclear reactor core is immersed in primary coolant water at or near the bottom of a pressure vessel. In a typical design, the primary coolant is maintained in a subcooled liquid phase in a cylindrical pressure vessel that is mounted generally upright (that is, with its cylinder axis oriented vertically). A hollow cylindrical central riser is disposed concentrically inside the pressure vessel. Primary coolant flows upward through the reactor core where it is heated, rises through the central riser, discharges from the top of the central riser, and reverses direction to flow downward back toward the reactor core through a downcomer annulus.

The nuclear reactor core is built up from multiple fuel assemblies. Each fuel assembly includes a number of fuel rods. Control rods comprising neutron absorbing material are inserted into and lifted out of the reactor core to control core reactivity. The control rods are supported and guided through control rod guide tubes which are in turn supported by guide tube frames. In the integral PWR design, at least one steam generator is located inside the pressure vessel, typically in the downcomer annulus, and the pressurizer is located at the top of the pressure vessel, with a steam space at the top most point of the reactor. Alternatively an external pressurizer can be used to control reactor pressure.

A set of control rods is arranged as a control rod assembly that includes the control rods connected at their upper ends with a spider, and a connecting rod extending upward from the spider. The control rod assembly is raised or lowered to move the control rods out of or into the reactor core using a control rod drive mechanism (CRDM). In a typical CRDM configuration, an electrically driven motor selectively rotates a roller nut assembly or other threaded element that engages a lead screw that in turn connects with the connecting rod of the control rod assembly. The control rods are typically also configured to “SCRAM”, by which it is meant that the control rods can be quickly released in an emergency so as to fall into the reactor core under force of gravity and quickly terminate the power-generating nuclear chain reaction. Toward this end, the roller nut assembly may be configured to be separable so as to release the control rod assembly and lead screw which then fall toward the core as a translating unit. In another configuration, the connection of the lead screw with the connecting rod is latched and SCRAM is performed by releasing the latch so that the control rod assembly falls toward the core while the lead screw remains engaged with the roller nut. See Stambaugh et al., “Control Rod Drive Mechanism for Nuclear Reactor”, U.S. Pub. No. 2010/0316177 A1 published Dec. 16, 2010 which is incorporated herein by reference in its entirety; and DeSantis, “Control Rod Drive Mechanism for Nuclear Reactor”, U.S. Pub. No. 2011/0222640 A1 published Sep. 15, 2011 which is incorporated herein by reference in its entirety.

The CRDMs are complex precision devices which require electrical power to drive the motor, and may also require hydraulic, pneumatic, or another source of power to overcome the passive SCRAM release mechanism (e.g., to hold the separable roller nut in the engaged position, or to maintain latching of the connecting rod latch) unless this is also electrically driven. In existing commercial nuclear power reactors, the CRDMs are located externally, i.e. outside of the pressure vessel, typically above the vessel in PWR designs, or below the reactor in boiling water reactor (BWR) designs. An external CRDM has the advantage of accessibility for maintenance and can be powered through external electrical and hydraulic connectors. However, the requisite mechanical penetrations into the pressure vessel present safety concerns. Additionally, in compact integral PWR designs, especially those employing an internal pressurizer, it may be difficult to configure the reactor design to allow for overhead external placement of the CRDMs. Accordingly, internal CRDM designs have been developed. See U.S. Pub. No. 2010/0316177 A1 and U.S. Pub. No. 2011/0222640 A1 which are both incorporated herein by reference in their entireties. However, placing the CRDMs internally to the reactor vessel requires structural support and complicates delivery of electrical and hydraulic power. Hydraulic conductors are generally not flexible and are not readily engaged or disengaged, or spliced, making installation and servicing of internal CRDM units time consuming and labor-intensive.

Disclosed herein are improvements that provide various benefits that will become apparent to the skilled artisan upon reading the following.

### BRIEF SUMMARY

In some illustrative embodiments, an apparatus comprises: a nuclear reactor; an internal control rod drive mechanism (CRDM) including a hydraulically driven element connected by at least one hydraulic line with at least one hydraulic connector disposed on a mounting plate of the internal CRDM; and a support element mounted in the nuclear reactor and including at least one hydraulic connector. The internal CRDM is supported on the support element by the mounting plate of the CRDM with each hydraulic connector of the internal CRDM mated with a corresponding hydraulic connector of the support element. In some embodiments the hydraulically driven element of the internal CRDM is a hydraulically driven piston controlling SCRAM of the internal CRDM. In some embodiments the nuclear reactor comprises a pressure vessel containing a nuclear reactor core comprising fissile material immersed in coolant water, and the hydraulically driven element is driven by coolant water. In some such embodiments the coolant water pressure in the at least one hydraulic line is higher than the coolant water pressure in the pressure vessel and the mating of each hydraulic connector of the internal CRDM with a corresponding hydraulic connector of the support element comprises a leaky mating that leaks coolant water into the pressure vessel. In some embodiments the mated assembly of each hydraulic connector of the internal CRDM mated with its corresponding hydraulic connector of the support element includes a compliance feature, such as a wave spring. In some embodiments the support element comprises a distribution plate including hydraulic lines disposed on or in the distribution plate and connecting with the at least one hydraulic connector of the distribution plate.

In some illustrative embodiments, a method comprises: providing an internal control rod drive mechanism (CRDM) including a mounting plate and at least one hydraulically driven element connected by at least one hydraulic line with at least one hydraulic connector disposed on the mounting plate; and installing the internal CRDM inside a nuclear reactor. The installing includes placing the mounting plate of the internal CRDM onto a support element inside the nuclear reactor, and the placing causes each hydraulic connector of the internal CRDM to mate with a corresponding hydraulic connector of the support element. In some embodiments the nuclear reactor contains coolant water and the installing is performed with the internal CRDM submerged in the coolant water. In some embodiments the method further includes, after the installing, applying coolant water to the hydraulically driven element of the internal CRDM via a positive coolant water pressure in the at least one hydraulic line of the internal CRDM respective to coolant water pressure inside the nuclear reactor (e.g., 50-100 psi higher than coolant water pressure inside the nuclear reactor in some embodiments). In some such embodiments the mating of each hydraulic connector of the internal CRDM with a corresponding hydraulic connector of the support element comprises a leaky connection between each hydraulic connector of the internal CRDM and the corresponding hydraulic connector of the support element such that the leaky connection leaks coolant water into the nuclear reactor.

In some illustrative embodiments, an apparatus comprises an internal control rod drive mechanism (CRDM) including as a unitary assembly: an electric motor; a hydraulically driven element; a mounting plate; a hydraulic connector disposed on the mounting plate; and a hydraulic line extending from the hydraulically driven element to the hydraulic connector disposed on the mounting plate. In some embodiments the apparatus further includes a distribution plate including hydraulic lines disposed on or in the distribution plate, one of which hydraulic lines terminates in a hydraulic connector disposed on the distribution plate, and the mounting plate of the internal CRDM and the distribution plate are configured such that the mounting plate of the internal CRDM can be placed onto the distribution plate with the hydraulic connector disposed on the mounting plate of the internal CRDM mating with the hydraulic connector disposed on the distribution plate to form a hydraulic connection that includes a compressed compliance element (such as a compressed wave spring).

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically shows an integral pressurized water reactor (integral PWR) with the upper internals of the reactor inset.

FIG. 2 shows a perspective view of a distribution plate suitably used in the upper internals of the integral PWR of FIG. 1.

FIG. 3 is a detail of one of the openings of the distribution plate of FIG. 2.

FIG. 4 illustrates a perspective view of a standoff assembly for mounting on the distribution plate of FIG. 2.

FIG. 5 illustrates a view of the standoff assembly of FIG. 4 from a different perspective.

FIGS. 6A and 6B illustrates the standoff assembly of FIGS. 4 and 5 connected to a Control Rod Drive Mechanism (CRDM) and accompanying guide tube, with a detail of the connectors shown in inset 6B.

FIG. 7 illustrates the standoff assembly of FIGS. 4, 5, and 6 connected to a Control Rod Drive Mechanism.

FIG. 8 is a cutaway view of the hydraulic connection between the standoff assembly and the distribution plate.

FIGS. 9A-9E is a sequence showing the installation of the standoff assembly of FIGS. 4-6 onto the distribution plate of FIG. 2.

FIG. 10 is the female hydraulic connector of the standoff assembly of FIGS. 4-6 shown in cutaway.

FIG. 11 is an exploded cutaway isolation view of the female hydraulic connector of FIG. 10.

FIG. 12 is a detail of the male hydraulic connector of the distribution plate of FIG. 2 shown removed from the distribution plate.

FIG. 13 illustrates a method of connecting a CRDM with standoff assembly to a distribution plate.

FIG. 14 illustrates a method of removing a CRDM and standoff assembly from a distribution plate.

### DETAILED DESCRIPTION OF THE PREFERRED EMBODIMENTS

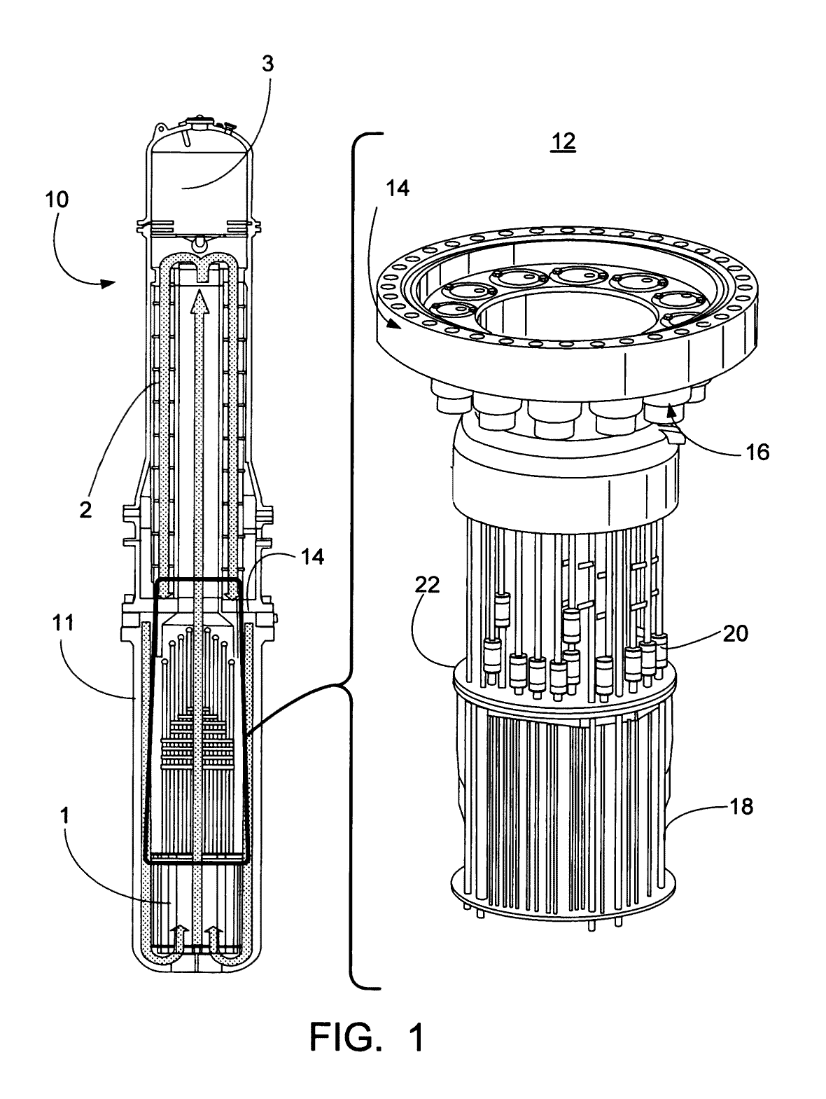

FIG. 1 illustrates an integral Pressurized Water Reactor (integral PWR) generally designated by the numeral 10. A reactor vessel 11 is generally cylindrical and contains a nuclear reactor core 1 comprising fissile material (e.g. ²³⁵U), steam generators 2, and a pressurizer 3. Although an integral pressurized water reactor (PWR) is depicted, a boiling water reactor (BWR), PWR with external steam generators, or other type of nuclear reactor is also contemplated. Moreover, while the disclosed rapid installation and servicing techniques are described with reference to illustrative internal CRDM units, these techniques are readily adapted for use with other internal nuclear reactor components such as internal reactor coolant pumps.

In the illustrative PWR, above the core 1 are the reactor upper internals 12 of integral PWR 10, shown in inset. The upper internals 12 are supported laterally by a mid-flange 14, which in the illustrative embodiment also supports internal canned reactor coolant pumps (RCPs) 16. More generally, the RCPs may be external pumps or have other configurations, and the upper internals may be supported otherwise than by the illustrative mid flange 14. The upper internals include control rod guide frames 18 to house and guide the control rod assemblies for controlling the reactor. Control Rod Drive Mechanisms (CRDMs) 20 raise and lower the control rods to control the reactor. In accordance with one embodiment, a CRDM distribution plate 22 supports the CRDMs and provides power and hydraulics to the CRDMs.

Control rods are withdrawn from the core by CRDMs to provide enough positive reactivity to achieve criticality. The control rod guide tubes provide space for the rods and interconnecting spider to be raised upward away from the reactor core. The CRDMs 20 require electric power for the motors which move the rods, as well as for auxiliary electrical components such as rod position indicators and rod bottom sensors. In some designs, the force to latch the connecting rod to the lead screw, or to maintain engagement of the separable roller nut, is hydraulic, necessitating a hydraulic connection to the CRDM. To ensure passive safety, a positive force is usually required to prevent SCRAM, such that removal of the positive force initiates a SCRAM. The illustrative CRDM 20 is an internal CRDM, that is, is located inside the reactor vessel, and so the connection between the CRDM 20 and the distribution plate 22 is difficult to access. Servicing of a CRDM during a plant shutdown should preferably be rapid in order to minimize the length of the shutdown. To facilitate replacing a CRDM in the field, a standoff assembly connected to the distribution plate 22 to provide precise vertical placement of the CRDM 20 is also configured to provide electrical power and hydraulics to the CRDM 20 via connectors that require no action to effectuate the connection other than placement of the standoff assembly onto the distribution plate 22. After placement, the standoff is secured to the distribution plate by bolts or other fasteners. Additionally or alternatively, it is contemplated to rely upon the weight of the standoff assembly and CRDM to hold the assembly in place, or to use welds to secure the assembly.

The illustrative distribution plate 22 is a single plate that contains the electrical and hydraulic lines and also is strong enough to provide support to the CRDMs and upper internals without reinforcement. In another other embodiment, the distribution plate 22 may comprise a stack of two or more plates, for example a mid-hanger plate which provides structural strength and rigidity and an upper plate that contains electrical and/or hydraulic lines to the CRDMs via the standoff assembly.

The motor/roller nut assembly of the CRDM is generally located in the middle of the lead screw's travel path. When the control rod is fully inserted into the core, the roller nut is holding near the top of the lead screw, and, when the rod is at the top of the core, the roller nut is holding near the bottom of the lead screw and most of the length of the lead screw extends upward above the motor/roller nut assembly. Hence the distribution plate 22 that supports the CRDM is positioned “below” the CRDM units and a relatively short distance above the reactor core.

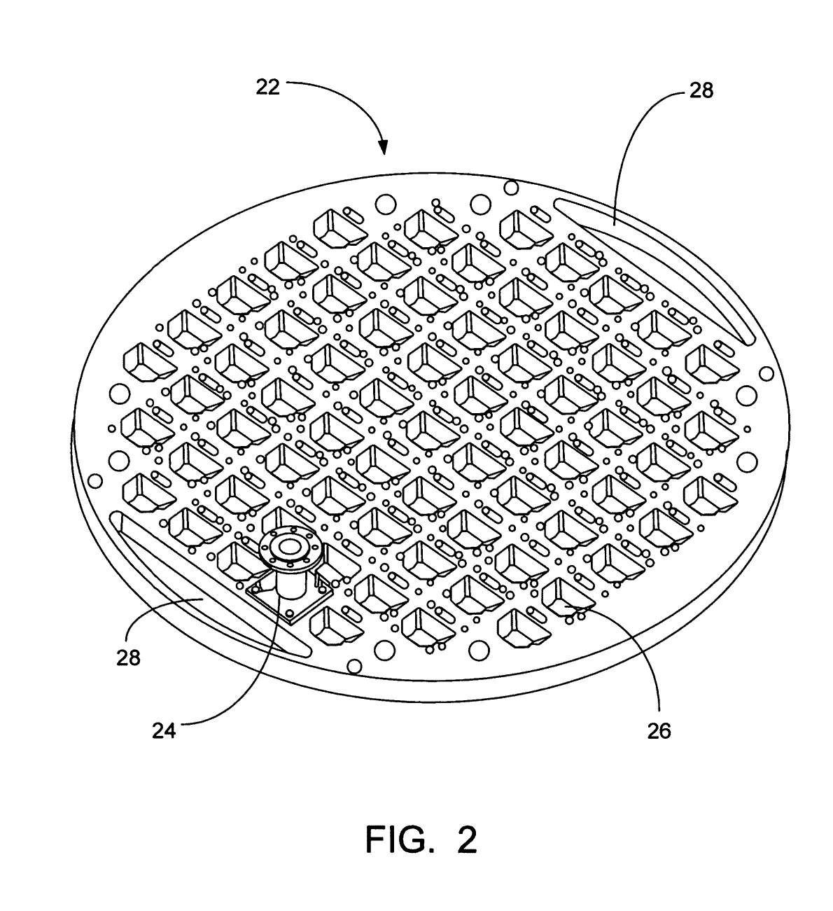

FIG. 2 illustrates the distribution plate 22 with one standoff assembly 24 mounted for illustration, though it should be understood that most or all openings 26 would have a standoff assembly (and accompanying CRDM) mounted in place during operation of the reactor. Each opening 26 allows a lead screw of a control rod to pass through. The periphery of the opening provides a connection site for a standoff assembly that supports the CRDM. The lead screw passes down through the CRDM, through the standoff assembly, and then through the opening 26. The distribution plate 22 has, either internally embedded within the plate or mounted to it, electrical power lines (e.g., electrical conductors) and hydraulic power lines to supply the CRDM with power and hydraulics. The illustrative openings 26 are asymmetric or keyed so that the CRDM can only be mounted in one orientation. As illustrated, there are 69 openings arranged in nine rows to form a grid, but more or fewer could be used depending on the number of control rods in the reactor. The distribution plate is circular to fit the interior of the reactor, with openings 28 to allow for flow through the plate. In some designs, not all openings may have CRDMs mounted to them or have associated fuel assemblies.

The CRDMs are supported by the CRDM standoff assembly which is attached to a distribution plate that provides power to the CRDMs. The connectors for the CRDM's are integrated into the power distribution plate assembly and the CRDM standoff plate. They allow the disconnection of the power and signal leads when CRDM maintenance is required without splicing MI cable.

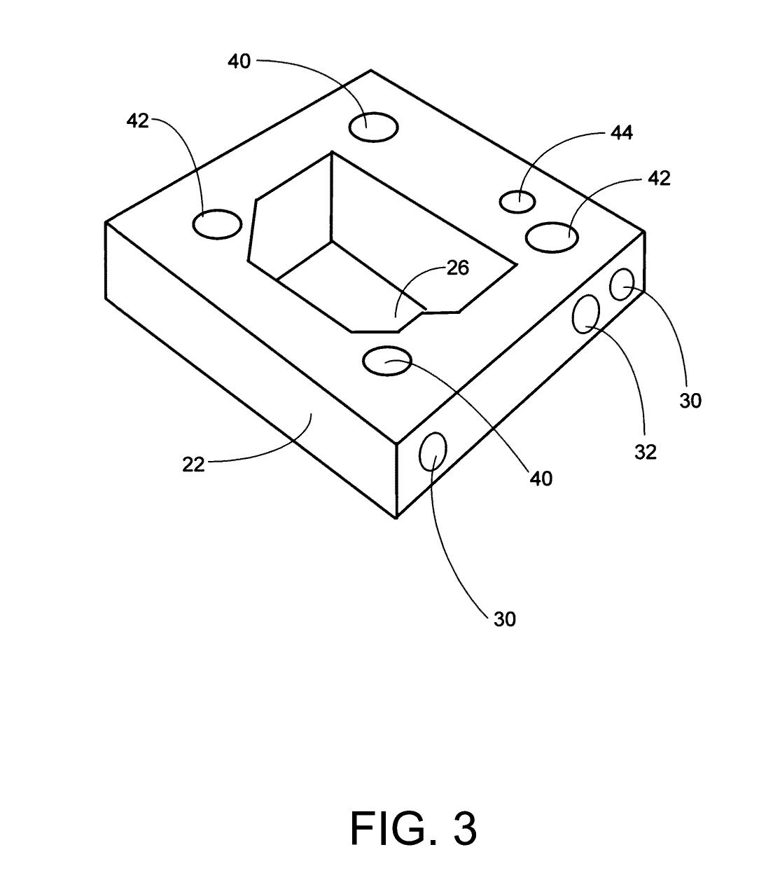

FIG. 3 schematically illustrates a small cutaway view of one connection site of the distribution plate 22 for connecting a CRDM to the distribution plate. The connection site includes an opening 26 for passing the lead screw of a single CRDM. Located around the opening 26 are apertures 40 to accept bolts (more generally, other securing or fastening features may be used) and electrical connectors 42 for delivering electrical power to the CRDM. The illustrative CRDM employs hydraulic power to operate the SCRAM mechanism, and accordingly there is also a hydraulic connector 44 to accept a hydraulic line connection. The opening 26 and its associated features 40, 42, 44 create a connection site to accept the CRDM/standoff assembly. Internal to the distribution plate 22 may be junction boxes to electrically connect the connection sites to the electrical power lines running in between rows of connection sites. Similarly, the hydraulic connector 44 may connect to a common hydraulic line running through the distribution plate separated by depth.

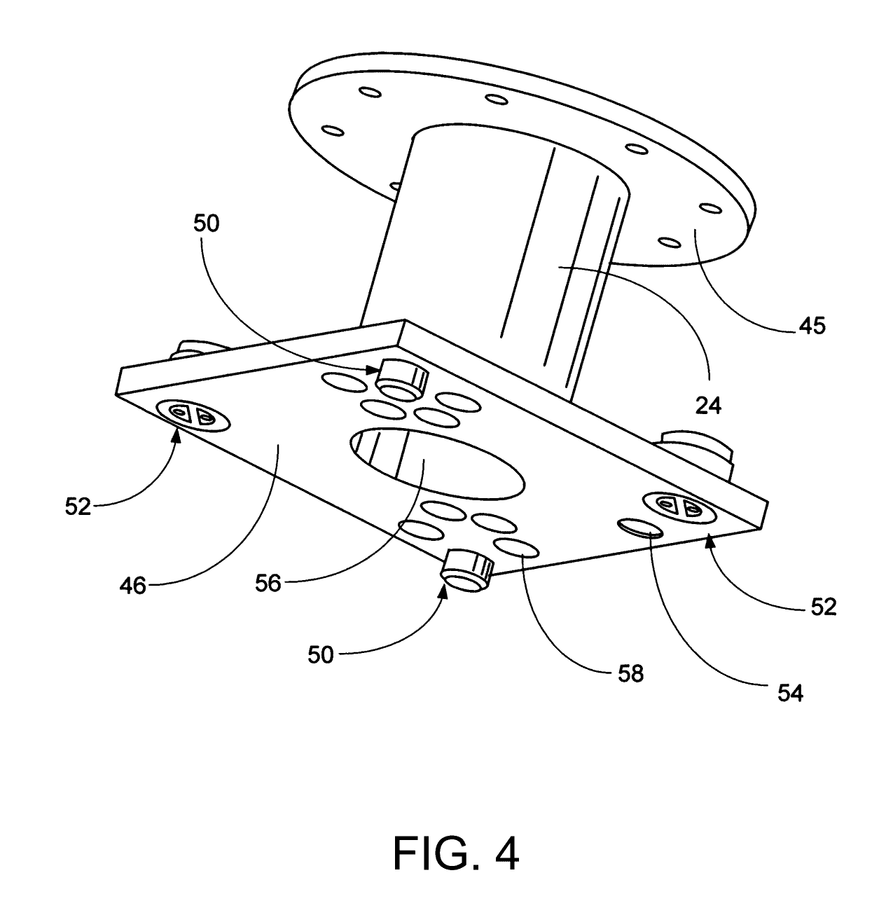

FIG. 4 illustrates a standoff 24 that suitably mates to opening 26 in the distribution plate 22. The standoff assembly has a cylindrical midsection with plates 45, 46 of larger cross-sectional area on either end of the midsection. The circular top plate 45 mates to and supports a CRDM 20. The square bottom plate 46 mates to the distribution plate 22. Although the illustrative bottom plate 46 is square, it may alternatively be round or have another shape. When the CRDM 20 and the top plate 45 of the standoff 24 are secured together they form a unitary CRDM/standoff assembly in which the bottom plate 46 is a flange for connecting the assembly to the distribution plate 22. Two bolt lead-ins 50 on diagonally opposite sides of the lower plate 46 mate to the apertures 40 of the distribution plate. The bolt lead-ins, being mainly for positioning the CRDM standoff, are the first component on the standoff to make contact with the distribution plate when the CRDM is being installed, ensuring proper alignment. Two electrical power connectors 52 on diagonally opposite corners of the bottom plate 46 mate to corresponding electrical power connectors 42 of the distribution plate 22. A hydraulic line connector 54 on the bottom plate 46 mates to the corresponding hydraulic power connector 44 of the distribution plate 22. A central bore 56 of the standoff 24 is aligned with the opening 26 of the mating site of the distribution plate 22 and allows the lead screw to pass through. The connectors 42, 44 inside the distribution plate 22 optionally have internal springs to ensure positive contact, and the opposing bolts that attach at lead-ins 50 serve as tensioning devices to ensure proper seating of both the CRDM electrical connectors and hydraulic connectors. Illustrative flow slots 58 permit primary coolant to flow through the standoff.

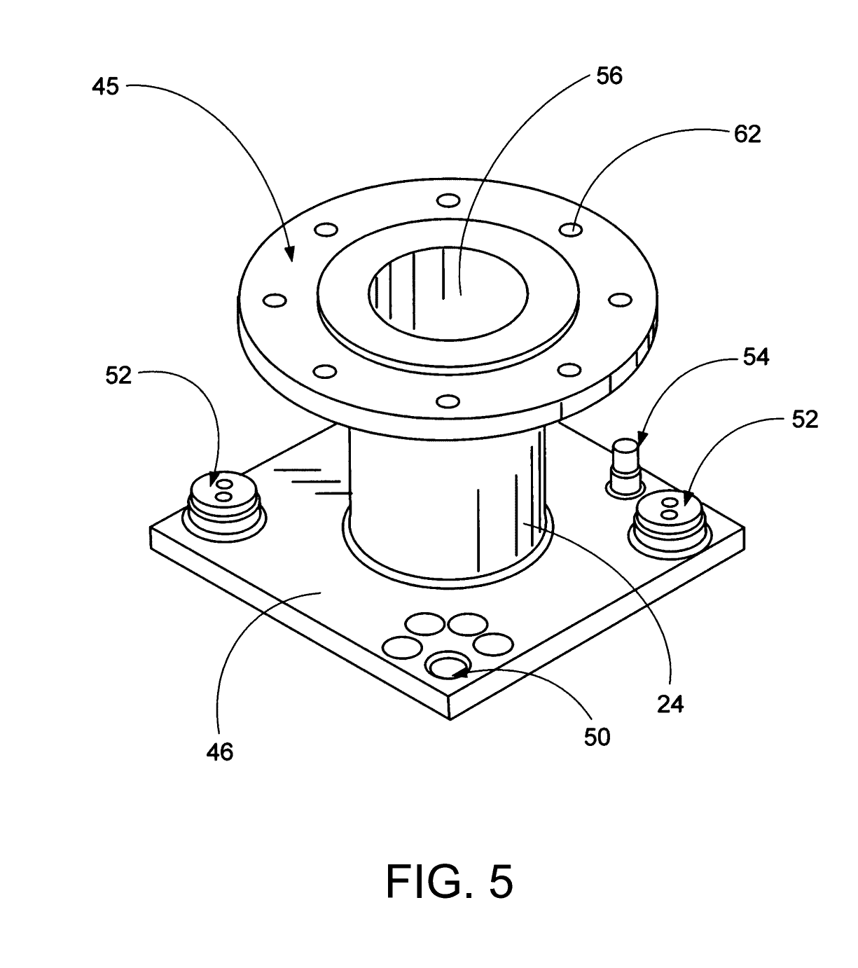

FIG. 5 illustrates a perspective view focusing on the top plate 45 of the standoff 24. The top plate 45 of the standoff mates to the CRDM and is attached via bolt holes 62. Bolt holes 62 may be either threaded or unthreaded. The CRDM and standoff can be attached to each other and electrical connections 52 and hydraulic connection 54 made before the CRDM is installed so as to form a CRDM/standoff assembly having flange 46 for connecting the assembly with the connection site of the distribution plate 22. The bottom plate 46 of the standoff 24 is secured to the connection site via bolts passing through holes 50 and secured by nuts, threads in the bolt holes 40, or the like.

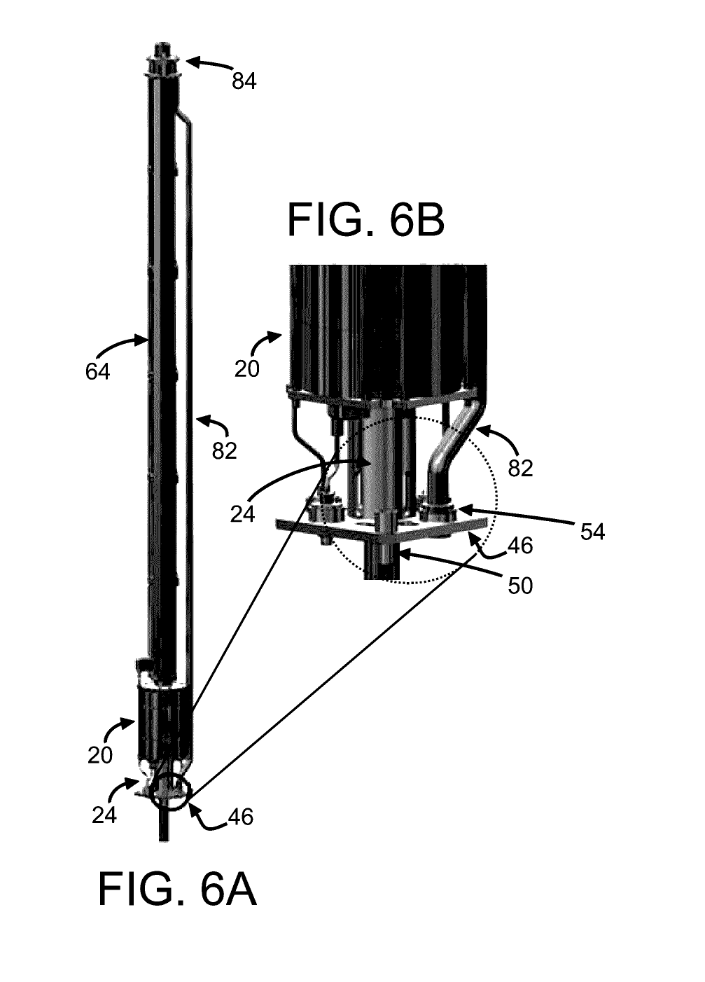

FIG. 6A shows a CRDM 20 with attached standoff 24 below. Above CRDM 20 is guide tube 64 that accommodates a screw of the CRDM when the control rod assembly is raised out of the reactor core (so that the lead screw extends above the CRDM motor). The illustrative guide tube 64 also includes a hydraulic latch that releases the connecting rod from the CRDM lead screw (components interior to the guide tube 64) during SCRAM. Such CRDM units are described in Stambaugh et al., “Control Rod Drive Mechanism for Nuclear Reactor”, U.S. Pub. No. 2010/0316177 A1 published Dec. 16, 2010 which is incorporated herein by reference in its entirety; and DeSantis, “Control Rod Drive Mechanism for Nuclear Reactor”, U.S. Pub. No. 2011/0222640 A1 published Sep. 15, 2011 which is incorporated herein by reference in its entirety. A hydraulic line 82 extends the length of the guide tube 64 to attach to a piston 84 at the top of the guide tube that operates the SCRAM latch. The hydraulic line 82 supplies hydraulic pressure to the piston 84 that, when pressurized, latches the connecting rod to the lead screw of the CRDM 20; upon loss of hydraulic pressure, the piston 84 depressurizes and releases the connecting rod to initiate SCRAM. Note that, in the embodiment of FIG. 6A, there is no return hydraulic line. The hydraulic piston uses primary coolant as its hydraulic fluid, and hydraulic pressure may be released by dumping the coolant into the primary. The piston may also leak by design, and a loss of hydraulic flow will cause the piston to bleed down and release the lead screw. With a leaky piston, hydraulic pressure will be maintained as long as the leak rate of the piston is less than the flow of hydraulic fluid. It is also contemplated that two hydraulic lines (a supply and return) may be used. Circled in FIG. 6A is the connector region on the lower plate 46, shown in inset in FIG. 6B, showing the bolt lead-ins 50.

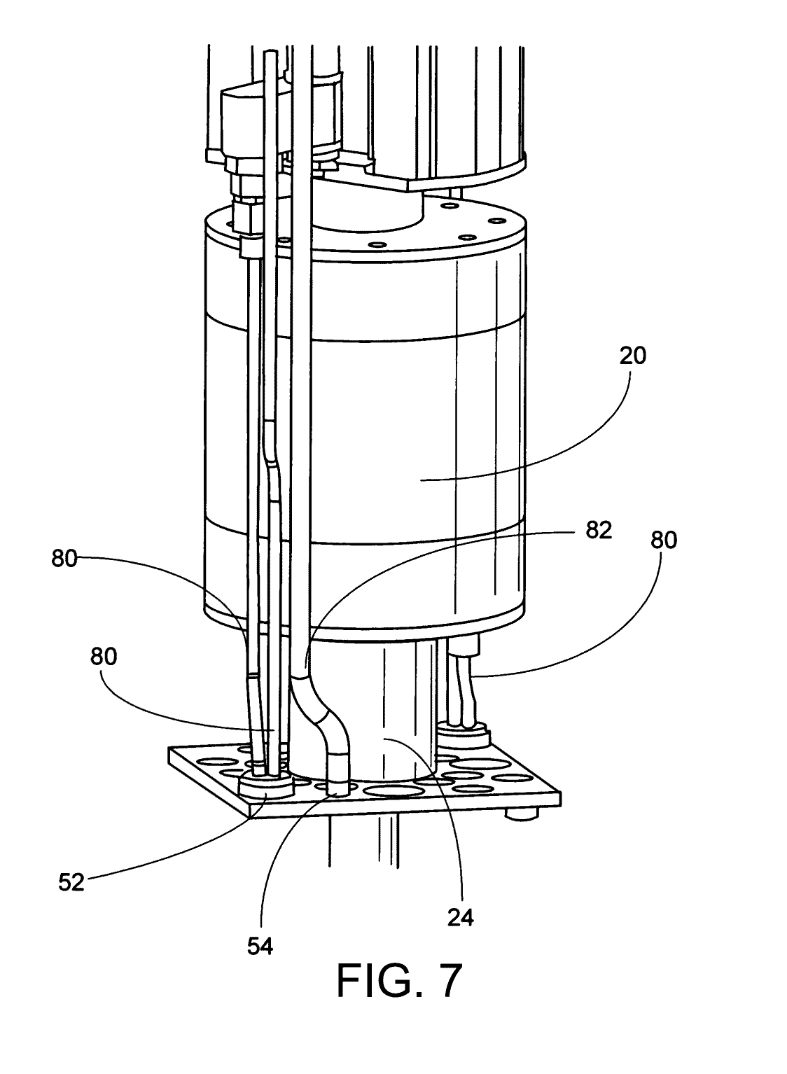

FIG. 7 shows another view of standoff 24 connected to a CRDM 20 to form a CRDM/standoff assembly that can be mounted to the distribution plate. CRDM electrical cabling 80 extends upward to conduct electrical power received at the electrical connectors 52 to the motor or other electrical component(s) of the CRDM 20. Similarly, a CRDM hydraulic line 82 extends upward to conduct hydraulic power received at hydraulic connector 54 to the hydraulic piston or other hydraulic component(s) of the CRDM 20 to maintain latching—removal of the hydraulic power instigates a SCRAM. The entire assembly including the CRDM and the standoff is then installed as a unit on a distribution plate, simplifying the installation process of a CRDM in the field.

The interface points (i.e., electrical and hydraulic connectors) in the embodiment of FIG. 7 are at the standoff assembly but could be at any location along the length of the CRDM. For the illustrative examples, the interface point at which the CRDM is broken from the upper internals is at the bottom of the CRDM. In one embodiment, the electrical cables 80 are mineral insulated cables (MI cables) which generally include one, two, three, or more copper conductors wrapped in a mineral insulation such as Magnesium Oxide which is in turn sheathed in a metal. The mineral insulation could also be aluminum oxide, ceramic, or another electrically insulating material that is robust in the nuclear reactor environment. MI cables are often sheathed in alloys containing copper, but copper would corrode and have a negative effect on reactor chemistry. Some contemplated sheathing metals include various steel alloys containing nickel and/or chromium, or a copper sheath with a protective nickel cladding.

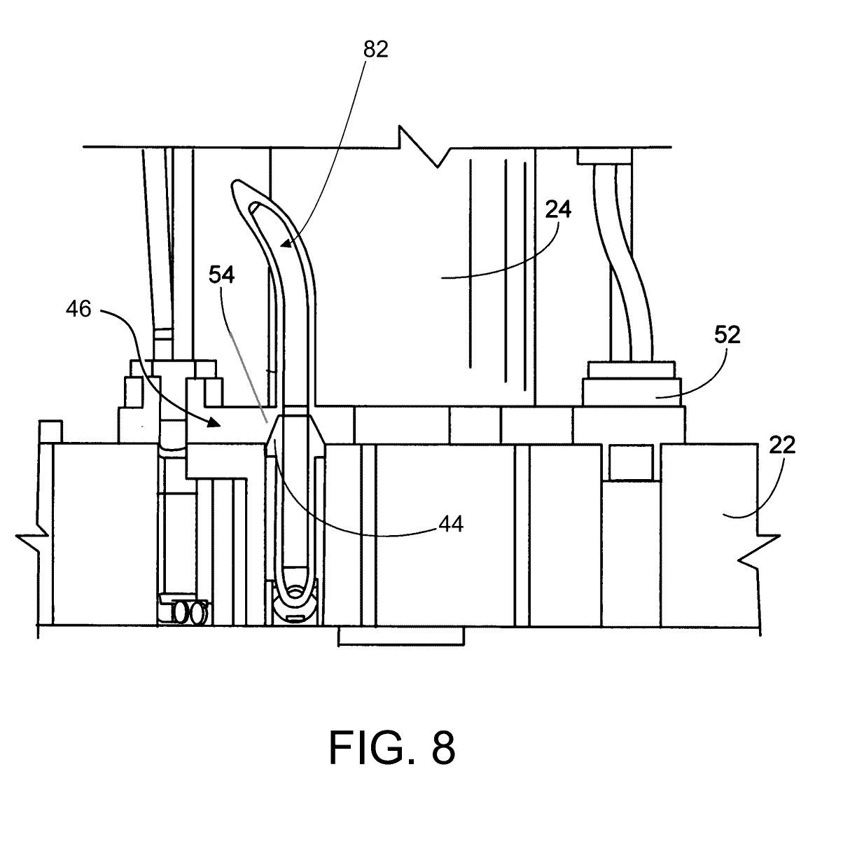

FIG. 8 shows a suitable hydraulic interface from standoff assembly 24 to distribution plate 22. An electrical connector 52 is also shown. The female hydraulic connector 54 of the standoff assembly mates to the male hydraulic connector 44. The female hydraulic connector 54 is a socket that is machined directly into the bottom of the lower plate 46 of the standoff assembly 24. The top of the female hydraulic connector 54 has a nipple to allow the hydraulic line 82 to be connected to the standoff assembly 22. The hydraulic line then runs up the CRDM to a piston assembly (not shown) which latches the lead screw.

A continuous flow of primary coolant is used as hydraulic fluid to maintain the CRDM latched during operation, so some leakage from the hydraulic connector (which is preferably purified primary coolant water) into the pressure vessel is acceptable. For example, in some embodiments the primary coolant pressure inside the hydraulic connector is 50-100 psi higher than the reactor pressure, leading to some outward leakage if the hydraulic connector has a loose fit and is not completely sealed. The optional loose fit advantageously relaxes the precision of alignment needed in mounting the CRDM. Accordingly, a sufficient sealing force for the (optionally leaky) hydraulic connection is provided by the weight of the CRDM/standoff assembly and/or the force imparted by the hold-down bolts that pass through the bolt lead-ins 50 of the standoff assembly and bolt holes 40 of the distribution plate. A wave spring of other tensioning device may provide further sealing.

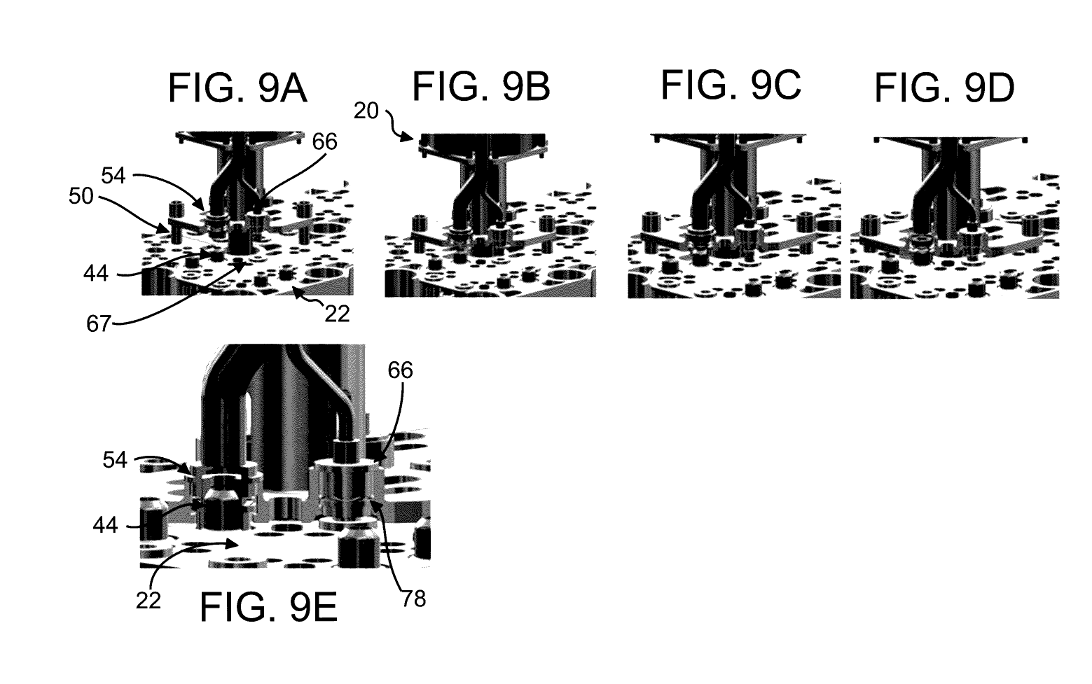

FIGS. 9A-9E shows the standoff assembly 24 (note that the standoff assembly is in partial cutaway) with attached CRDM 20 being installed. FIGS. 9A-D show the hydraulic connector 54 enveloping hydraulic connector 44. In FIG. 9A, the connectors and bolt lead-ins 50 have not yet made contact. In FIG. 9D, the bolt lead-ins 50 are inserted, and the hydraulic connection 54 has enveloped connector 44. In FIG. 9E, the hydraulic connector 54 (shown in cutaway) has completely surrounded connector 44 and is in contact with the distribution plate 22.

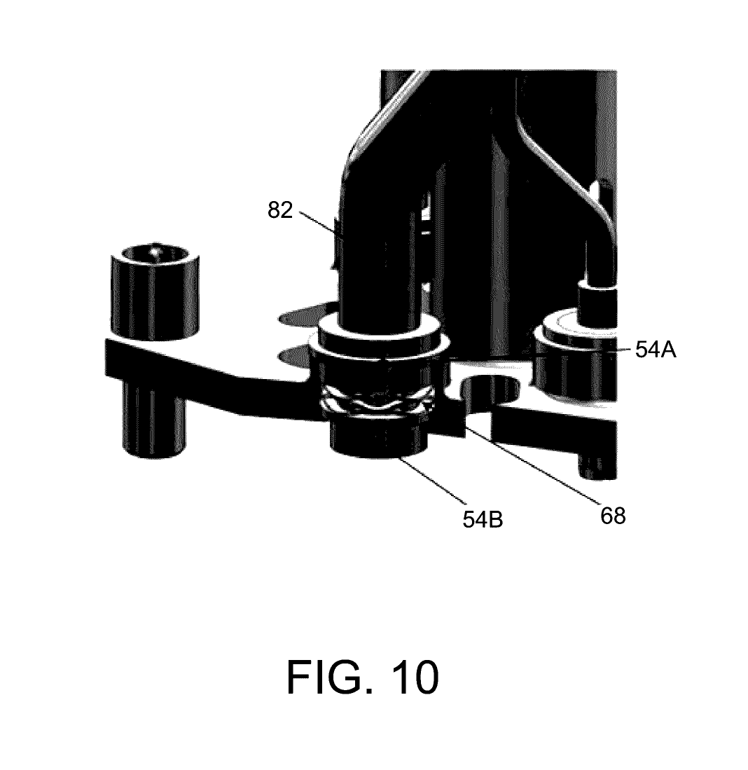

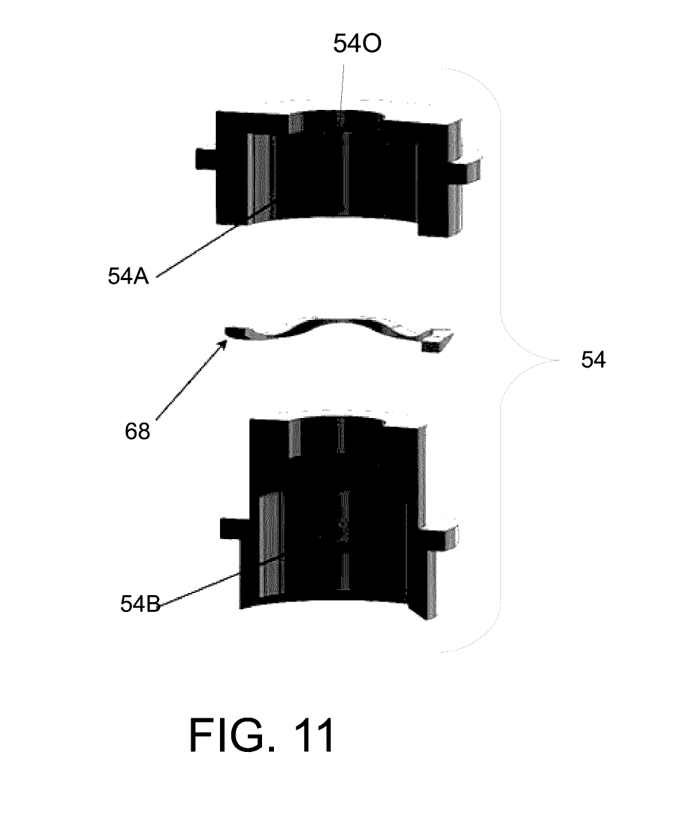

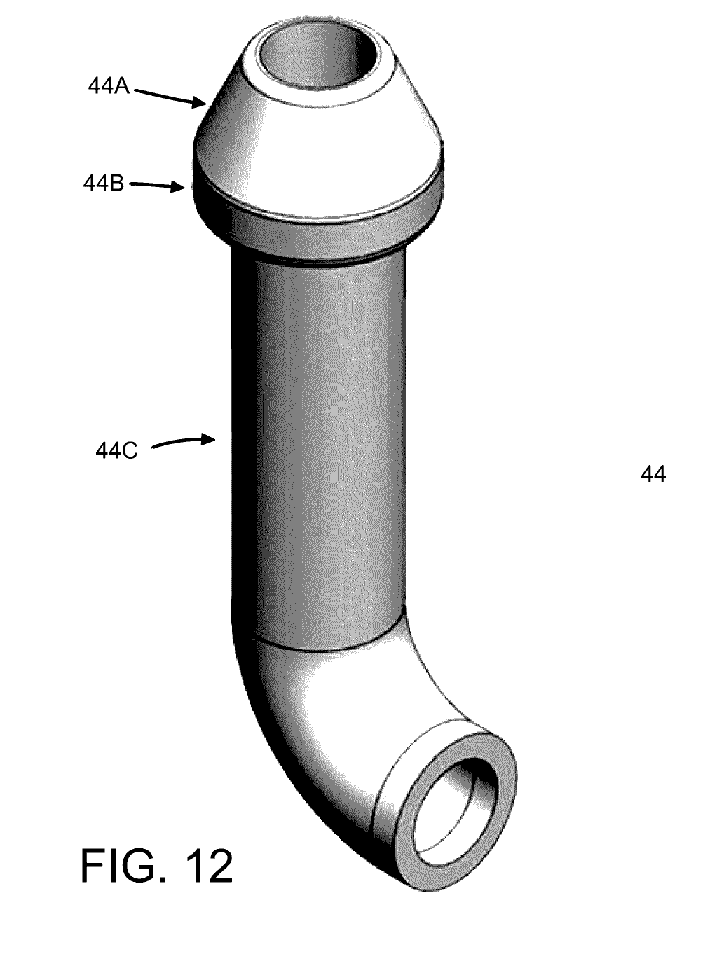

FIG. 10 shows a cutaway view of the female connector 54 mounted in the bottom plate 46. FIG. 11 shows an exploded cutaway isolation view of the female connector 54. The female connector 54 has a lower section 54B having a conical cavity sized to accept the conical section 44A of connector 44 (FIG. 12). A wave spring 68 ensures positive force on the conical section 54B, which lowers the leak rate of the connection. (Alternatively, the wave spring or other compliance element may be integrated into the connector of the distribution plate, or disposed between the connectors of the CRDM mounting plate and distribution plate). A top section 54A attaches to the standoff assembly and holds the connector in place, and includes an upper opening 540 providing fluid communication into the attached hydraulic line 82.

FIG. 12 shows an isolation view of the male hydraulic connector 44 that is shown in-place in the distribution plate 22 in FIG. 8. The hydraulic connector 44 has a conical section 44A that protrudes from the top surface of the distribution plate 22 (see FIG. 8) and is received by connector 54. The male connector 44 also includes a round (cylindrical) section 44B underneath the conical section that seals with the opening of the distribution plate 22 holding the connector 44, and a hydraulic line 44C extending from the connector that is suitably routed in or on the distribution plate.

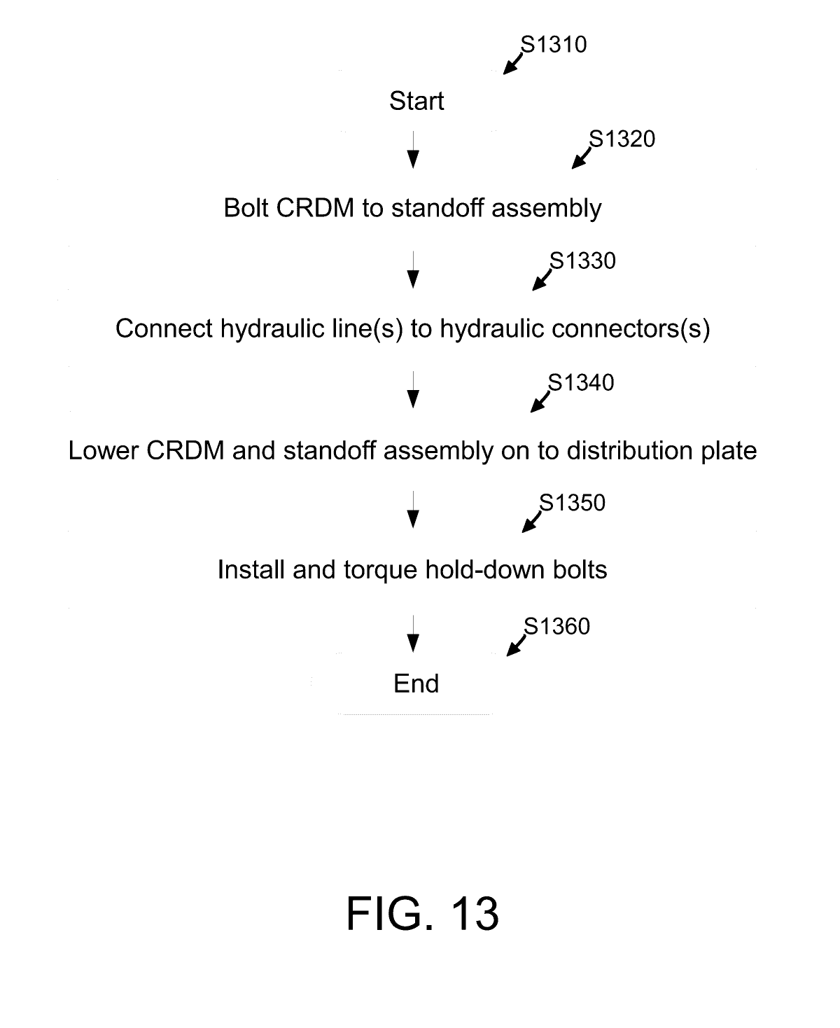

FIG. 13 diagrammatically illustrates a method of connecting a CRDM to a standoff to form a preassembled CRDM/standoff assembly and then connecting the CRDM/standoff assembly to the distribution plate. In step S1310, the method starts. In step S1320, the CRDM 20 is bolted to the standoff assembly 24 by a plurality of bolts. In step S1330, the hydraulic line(s) 80 are connected the hydraulic connection(s) 54 mounted on or in the lower plate 46 of the standoff 24. Note that these operations S1320, S1330 can be done prior to moving the assembly into the reactor pressure vessel. In step S1340, the standoff plate 24, with CRDM 20 bolted on top of it, is lowered onto the distribution plate 22, with the bolt holes 50 making contact first to ensure proper alignment of the standoff assembly and CRDM. In step S1350, the hold-down bolts are installed and torqued to attach the standoff assembly to the distribution plate and to ensure positive contact in the hydraulic and electrical connectors. At step S1360, the method ends. The operations S1340, S1350 are performed inside the reactor pressure vessel, and advantageously do not involve welding.

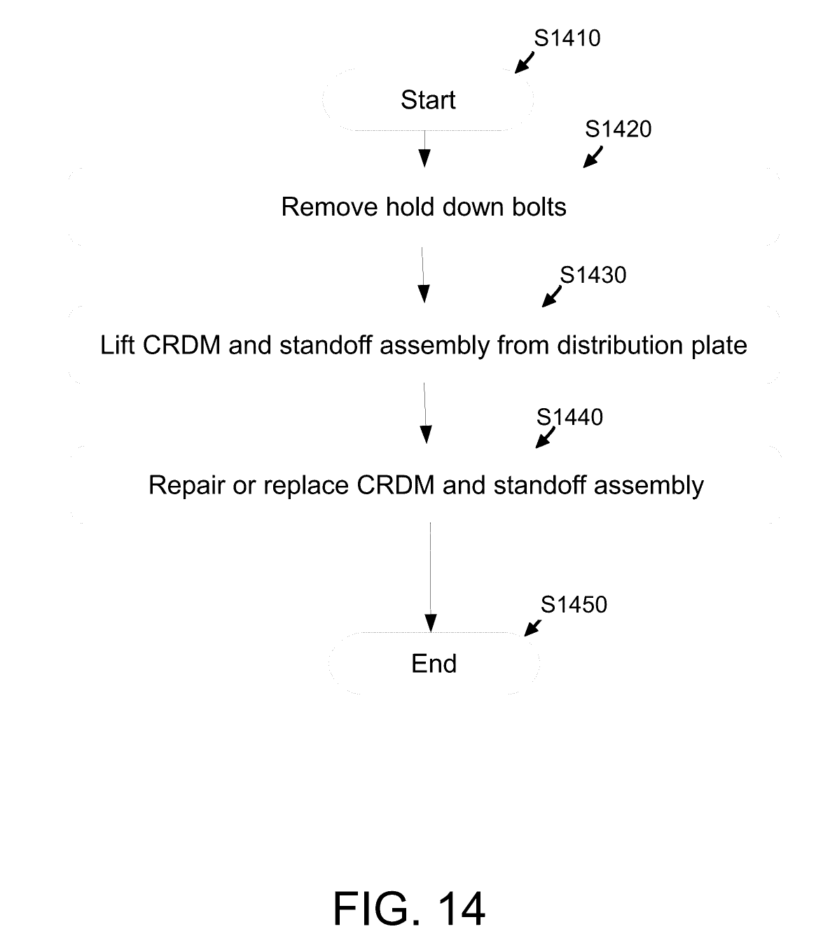

FIG. 14 illustrates a method of removing a CRDM from a distribution plate. In step S1410, the method starts. In step S1420, the hold-down bolts are removed. In step S1430, the CRDM and connected standoff assembly are lifted away from the distribution plate. In step S1440, the CRDM is optionally removed from the standoff assembly for repair or replacement. In step S1450, the method ends.

The disclosed approaches advantageously improve the installation and servicing of powered internal mechanical reactor components (e.g., the illustrative CRDM/standoff assembly) by replacing conventional in-field installation procedures including on-site routing and installation of hydraulic lines and connection of each line with the hydraulically powered internal mechanical reactor component with a “plug-and-play” installation that does not involve performing welding inside the reactor pressure vessel, and in which the hydraulic lines are integrated with the support plate and power connections are automatically made when the powered internal mechanical reactor component is mounted onto its support plate. The disclosed approaches leverage the fact that most powered internal mechanical reactor components are conventionally mounted on a support plate in order to provide sufficient structural support and to enable efficient removal for servicing (e.g., a welded mount complicates removal for servicing). By modifying the support plate to also serve as a power distribution plate with built-in connectors that mate with mating connectors of the powered internal mechanical reactor component during mounting of the latter, most of the installation complexity is shifted away from the power plant and to the reactor manufacturing site(s).

The example of FIGS. 1-14 is merely illustrative, and numerous variations are contemplated. For example, the CRDM/standoff assembly can be replaced by a CRDM with an integral mounting flange, that is, the standoff can be integrally formed with the CRDM as a unitary element (variant not shown).

As another contemplated modification, it will be appreciated that the female connector can be located in the supporting power distribution plate while the male connector can be located in the flange, standoff or other mounting feature of the internal mechanical reactor component.

It is also contemplated that sealing features, such as (metal) gaskets or o-rings could be incorporated into the connection to reduce or eliminate leakage.

It is also anticipated that the hydraulic line could pass through an opening in the standoff and be connected to the hydraulic line of the distribution plate by, for example, a threaded connector or a welded connection. It is also anticipated that a hydraulic return line could be added by using two hydraulic lines—a feed line and a return line.

The illustrative CRDM has an electric motor driving the fine movement of the control rod assembly during normal (i.e. non-SCRAM) operation, and the hydraulically driven element is the piston 84 (see FIG. 6A) controlling SCRAM of the internal CRDM. In this embodiment the mounting plate 46 includes both electrical and hydraulic connectors. In contemplated alternative embodiments (not shown) the fine movement is driven by a hydraulic mechanism, such as a hydraulic jack, in which case the hydraulic jack is the hydraulically driven element (and the SCRAM mechanism may be either hydraulically driven or electrically driven).

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. An apparatus comprising:
a nuclear reactor;
an internal control rod drive mechanism (CRDM) including a hydraulically driven element connected by at least one hydraulic line with at least one hydraulic connector disposed on a mounting plate of the internal CRDM; and
a support element mounted in the nuclear reactor and including at least one hydraulic connector;
wherein the internal CRDM is supported on the support element by the mounting plate of the CRDM with each hydraulic connector of the internal CRDM mated with a corresponding hydraulic connector of the support element.

2. The apparatus of claim 1 wherein the hydraulically driven element of the internal CRDM comprises a hydraulically driven piston controlling SCRAM of the internal CRDM.

3. The apparatus of claim 1 wherein the nuclear reactor comprises a pressure vessel containing a nuclear reactor core comprising fissile material immersed in coolant water, and the hydraulically driven element is driven by coolant water.

4. The apparatus of claim 3 wherein the coolant water pressure in the at least one hydraulic line is higher than the coolant water pressure in the pressure vessel and the mating of each hydraulic connector of the internal CRDM with a corresponding hydraulic connector of the support element comprises a leaky mating that leaks coolant water into the pressure vessel.

5. The apparatus of claim 1 wherein the at least one hydraulic connector includes two hydraulic connectors connected respectively with hydraulic lines providing flow into and out of the hydraulically driven element of the internal CRDM.

6. The apparatus of claim 1 wherein the at least one hydraulic connector includes a single hydraulic connector connected with a single hydraulic line providing flow into the hydraulically driven element of the internal CRDM.

7. The apparatus of claim 1 wherein the mated assembly of each hydraulic connector of the internal CRDM mated with its corresponding hydraulic connector of the support element includes a compliance feature.

8. The apparatus of claim 7 wherein the compliance feature is a wave spring.

9. The apparatus of claim 1 wherein the internal CRDM further includes an electric motor electrically connected with an electrical connector disposed on the mounting plate of the internal CRDM that mates with a corresponding electrical connector of the support element.

10. The apparatus of claim 1 where each hydraulic connector of the internal CRDM includes a lead-in feature configured to guide the mating of the hydraulic connector with the corresponding hydraulic connector of the support element.

11. The apparatus of claim 1 where the support element comprises a distribution plate including hydraulic lines disposed on or in the distribution plate and connecting with the at least one hydraulic connector of the distribution plate.

12. The apparatus of claim 11 wherein the distribution plate includes an opening sized to receive a lead screw operated by the internal CRDM, wherein the opening is keyed to permit mounting of the internal CRDM on the distribution plate only in a correct orientation.

13. The apparatus of claim 1 where the internal CRDM includes a standoff having an end comprising the mounting plate of the internal CRDM.

14. A method comprising:
providing an internal control rod drive mechanism (CRDM) including a mounting plate and at least one hydraulically driven element connected by at least one hydraulic line with at least one hydraulic connector disposed on the mounting plate; and
installing the internal CRDM inside a nuclear reactor, the installing including placing the mounting plate of the internal CRDM onto a support element inside the nuclear reactor, the placing causing each hydraulic connector of the internal CRDM to mate with a corresponding hydraulic connector of the support element.

15. The method of claim 14 wherein the nuclear reactor contains coolant water and the installing is performed with the internal CRDM submerged in the coolant water.

16. The method of claim 14 wherein the nuclear reactor contains coolant water and the method further comprises:
after the installing, applying coolant water to the hydraulically driven element of the internal CRDM via a positive coolant water pressure in the at least one hydraulic line of the internal CRDM respective to coolant water pressure inside the nuclear reactor.

17. The method of claim 16 wherein the mating of each hydraulic connector of the internal CRDM with a corresponding hydraulic connector of the support element comprises a leaky connection between each hydraulic connector of the internal CRDM and the corresponding hydraulic connector of the support element such that the leaky connection leaks coolant water into the nuclear reactor.

18. The method of claim 16 wherein the positive coolant water pressure in the at least one hydraulic line of the internal CRDM respective to coolant water pressure inside the nuclear reactor is 50-100 psi higher than coolant water pressure inside the nuclear reactor.

19. An apparatus comprising:
an internal control rod drive mechanism (CRDM) including as a unitary assembly:
an electric motor,
a hydraulically driven element,
a mounting plate,
a hydraulic connector disposed on the mounting plate, and
a hydraulic line extending from the hydraulically driven element to the hydraulic connector disposed on the mounting plate.

20. The apparatus of claim 19 further comprising:
a distribution plate including hydraulic lines disposed on or in the distribution plate, one of which hydraulic lines terminates in a hydraulic connector disposed on the distribution plate;
wherein the mounting plate of the internal CRDM and the distribution plate are configured such that the mounting plate of the internal CRDM can be placed onto the distribution plate with the hydraulic connector disposed on the mounting plate of the internal CRDM mating with the hydraulic connector disposed on the distribution plate to form a hydraulic connection.

21. The apparatus of claim 20 wherein the mounting plate of the internal CRDM is placed onto the distribution plate with the hydraulic connector disposed on the mounting plate of the internal CRDM mated with the hydraulic connector disposed on the distribution plate to form a hydraulic connection that includes a compressed compliance element.

22. The apparatus of claim 21 wherein the compressed compliance element is a compressed wave spring.
